(19) United States
(12) Patent Application Publication
(10) Pub. No.: US 2004/0242180 A1
(43) Pub. Date: Dec. 2, 2004

(54) Linearised mixer using frequency retranslation

(76) Inventors: Mark Beach, Bristol (GB); Tayfun Nesimoglu, Bristol (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/484,533

(22) PCT Filed: Jul. 18, 2002
(86) PCT No.: PCT/GB02/03293

(30) Foreign Application Priority Data
Jul. 20, 2001 (GB) 0117801.1

(51) Int. Cl. H04B 1/26

(52) U.S. Cl. 455/323; 455/302

(57) ABSTRACT

A mixer architecture receives an input signal, which is frequency translated from a first frequency to a second frequency in a first mixer; the resulting output signal is retranslated back to the first frequency in a second mixer, the retranslated signal is added to a sample of the input, with gain and phase control, and the resulting error signal is added to the input signal when it is applied to the first mixer. This linearises the mixer output by compensating for any distortion introduced in the forward path. The mixer architecture is applicable for use in receivers or transmitters.

This invention relates to frequency translation, and in particular to a mixer architecture, which can be used for downconversion or upconversion of signals between frequencies. For example, the mixer architecture can be used in a radio receiver, in order to downconvert received radio frequency signals to an intermediate frequency or to baseband, or can be used in a radio transmitter, in order to upconvert signals to the transmission frequency.

A problem which can arise with mixers is that they can introduce spectral spreading as a result of nonlinearity. For example, in the case of radio receivers, there is distortion caused by the presence of strong signals in the bands and channels adjacent to the wanted signal, which may block the demodulation of the wanted information by creating inband interference to the wanted channel.

In order to linearise a mixer output, feedforward mixer architectures have been proposed in Electronics Letters Vol. 35 No. 9 pages 724-5, “Linearised microwave mixer using simplified feedforward technique”, Chongcheawchamnan and Robertson, and in 1998 IEEE MTT-S Digest pages 1423-6, “A Modified Feed-Forward Technique for Mixer Linearization”, Ellis. In these architectures, an RF input signal is sampled. The main path signal is passed to a main mixer, and the sample is passed to a second mixer at a different power level. The output of the second mixer is then adjusted in its gain and phase, and subtracted from the output of the main mixer, in order to suppress any intermodulation products appearing therein.

However, this requires that the two mixers should be identical, and is very sensitive to any differences between them, as well as exhibiting a high noise figure.

According to the present invention, there is provided a mixer architecture, in which a mixer input signal is predistorted by an error signal, the error signal being formed by frequency retranslation of the mixer output signal and cancellation of the mixer input signal from the retranalated signal.

More specifically, there is provided a mixer architecture, in which an input signal is frequency translated from a first frequency to a second frequency in a first mixer; the resulting output signal is retranslated back to the first frequency in a second mixer; the retranslated signal is added to a sample of the input, with gain and phase control, and the resulting error signal is added to the input signal when it is applied to the first mixer.

The error signal can include all of the distortion products,. which can then be cancelled to compensate for any distortion in the forward path.

For a better understanding of the present invention, and to show how it may be put into effect, reference will now be made, by way of example, to the accompanying drawings, in which:

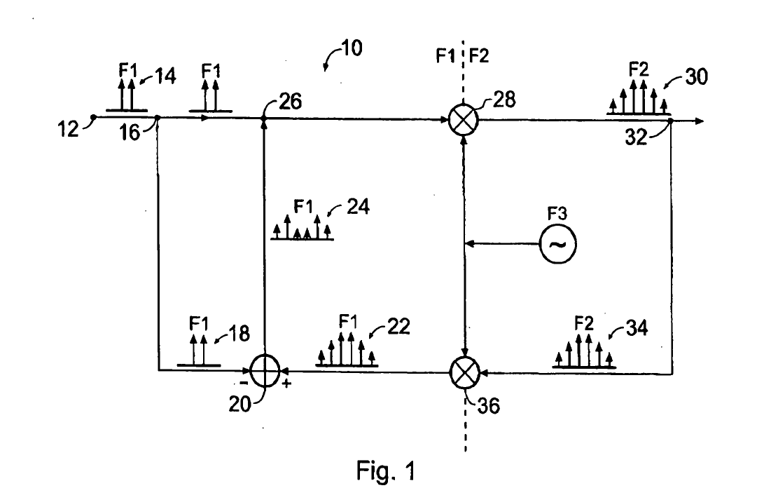

FIG. 1 is a schematic diagram, showing the basic form of mixer circuitry in accordance with the present invention.

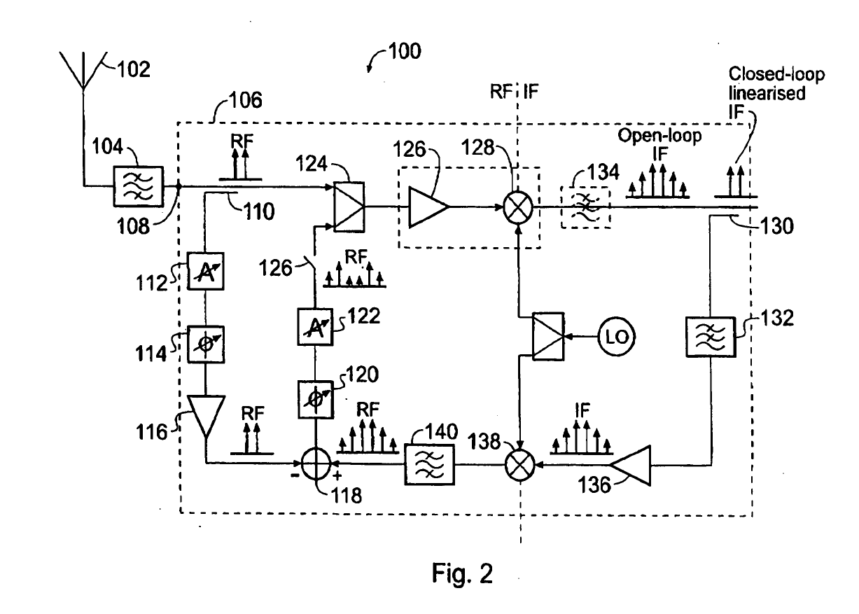

FIG. 2 is a block diagram, showing a radio receiver architecture in accordance with the invention.

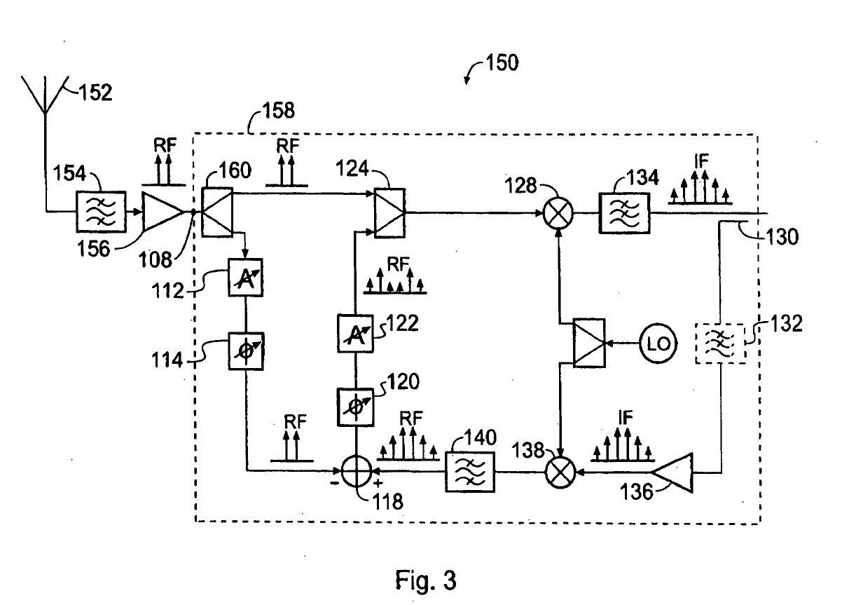

FIG. 3 is a block diagram, showing a radio receiver architecture in accordance with the invention.

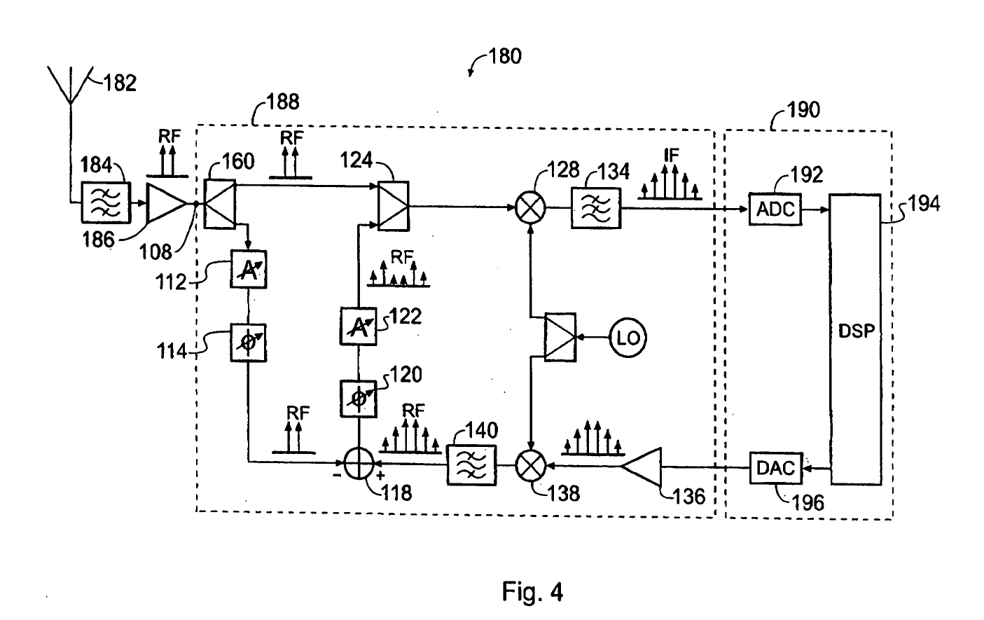

FIG. 4 is a block diagram, showing a radio receiver architecture in accordance with the invention.

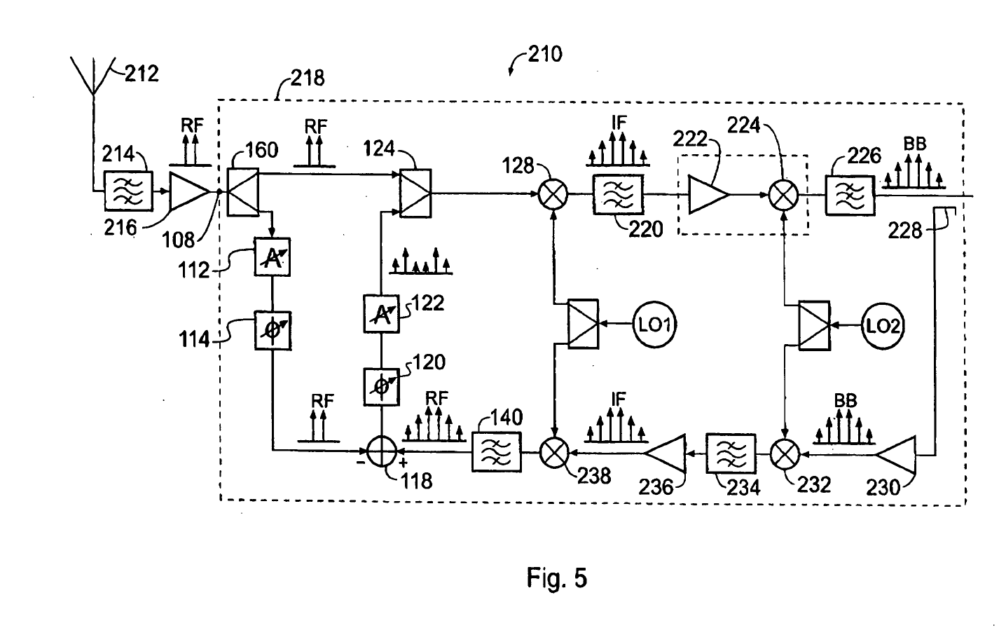

FIG. 5 is a block diagram, showing a radio receiver architecture in accordance with the invention.

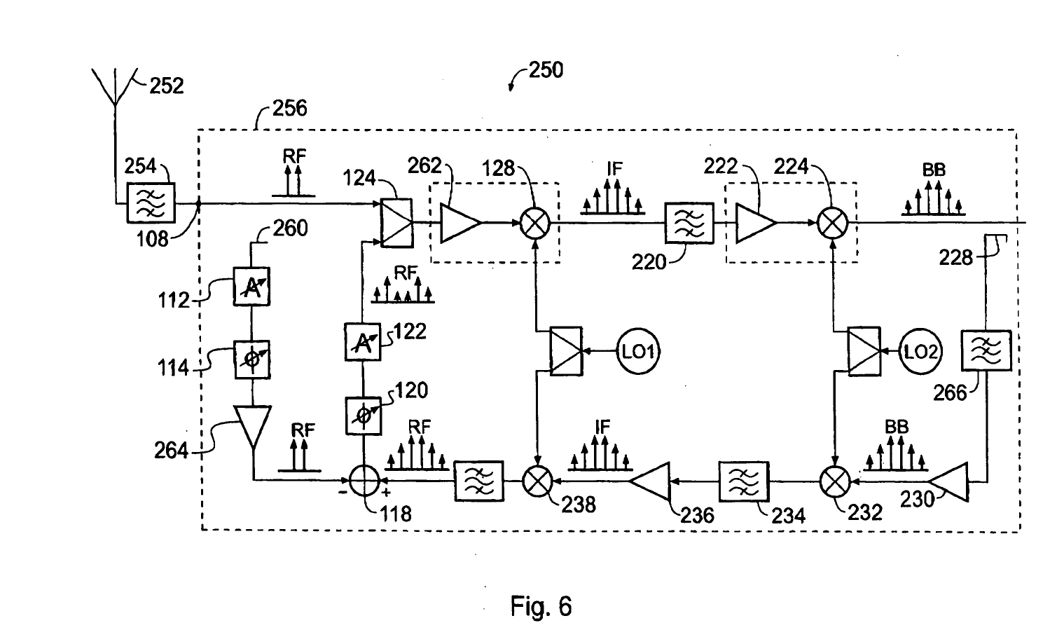

FIG. 6 is a block diagram, showing a radio receiver architecture in accordance with the invention.

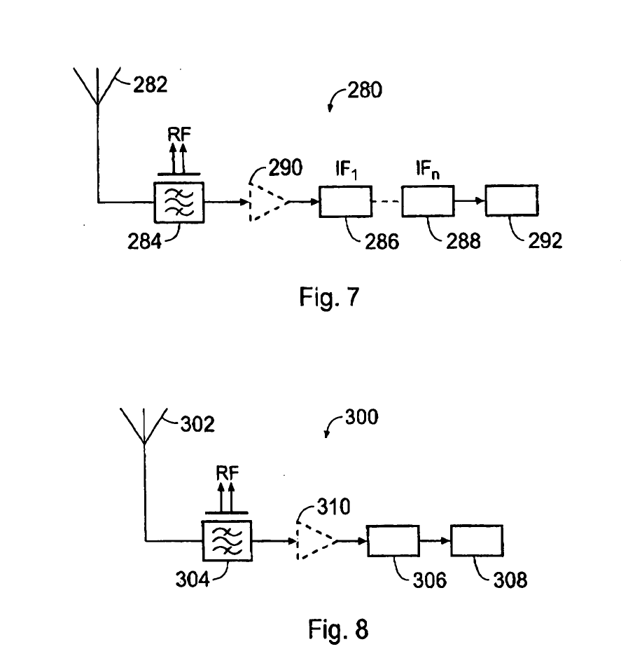

FIG. 7 is a schematic diagram, showing the general form of further radio receiver architectures in accordance with the invention.

FIG. 8 is a schematic diagram, showing the general form of further radio receiver architectures in accordance with the invention.

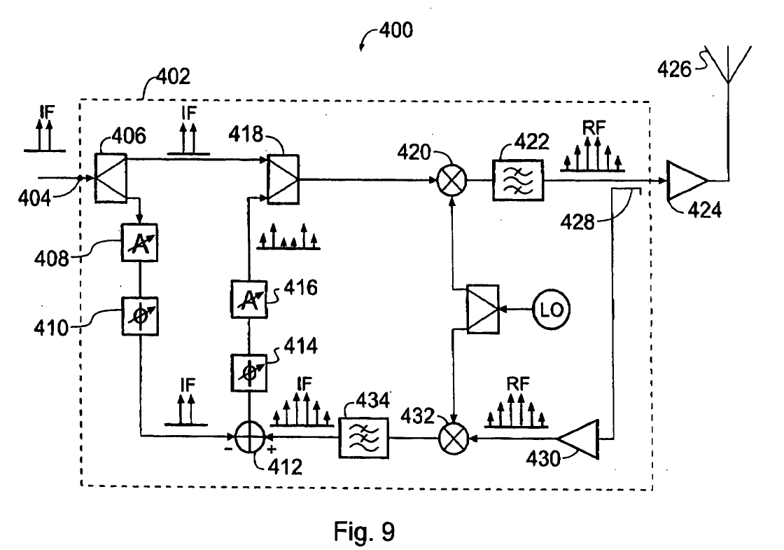

FIG. 9 is a block diagram, showing a radio transmitter architecture in accordance with the invention.

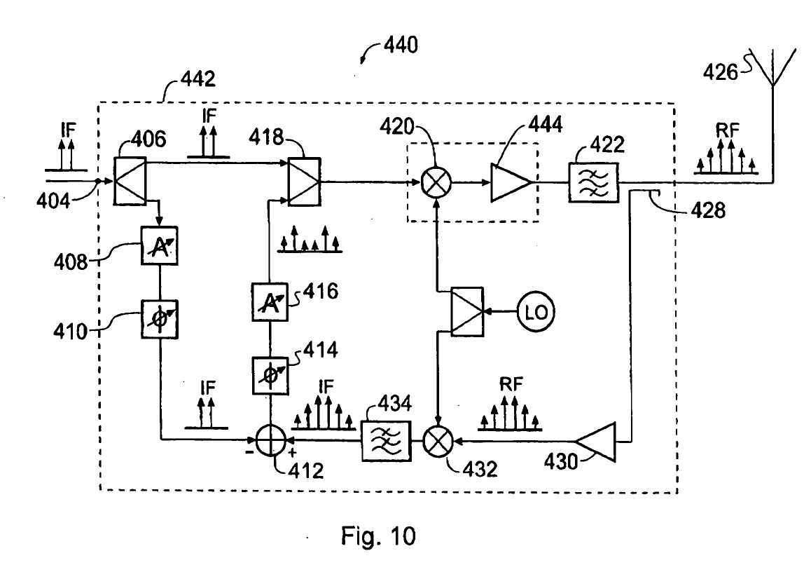

FIG. 10 is a block diagram, showing a radio transmitter architecture in accordance with the invention.

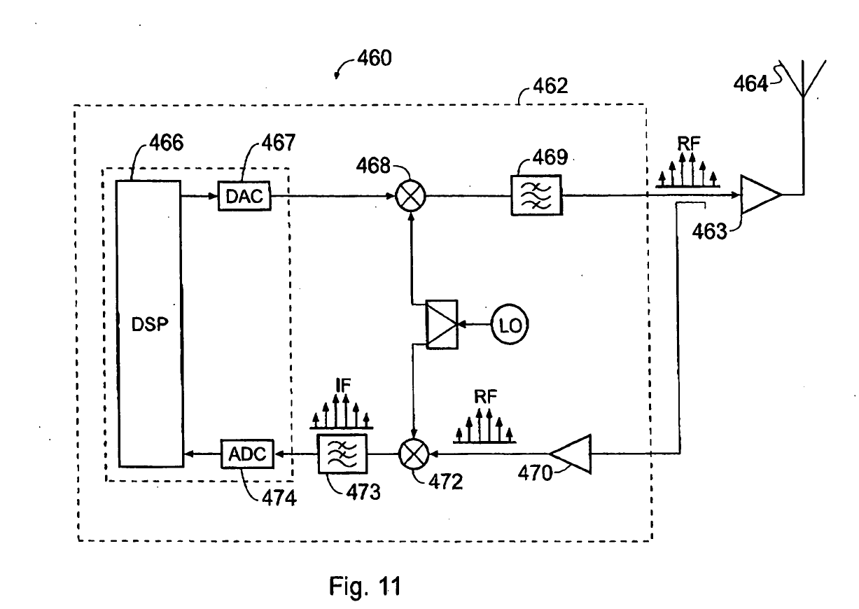

FIG. 11 is a block diagram, showing a radio transmitter architecture in accordance with the invention.

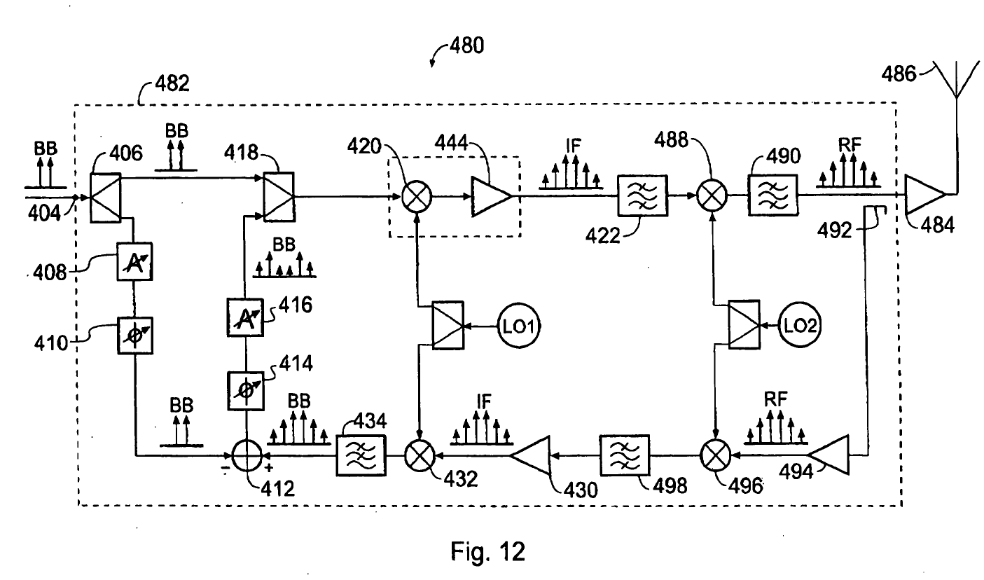

FIG. 12 is a block diagram, showing a radio transmitter architecture in accordance with the invention.

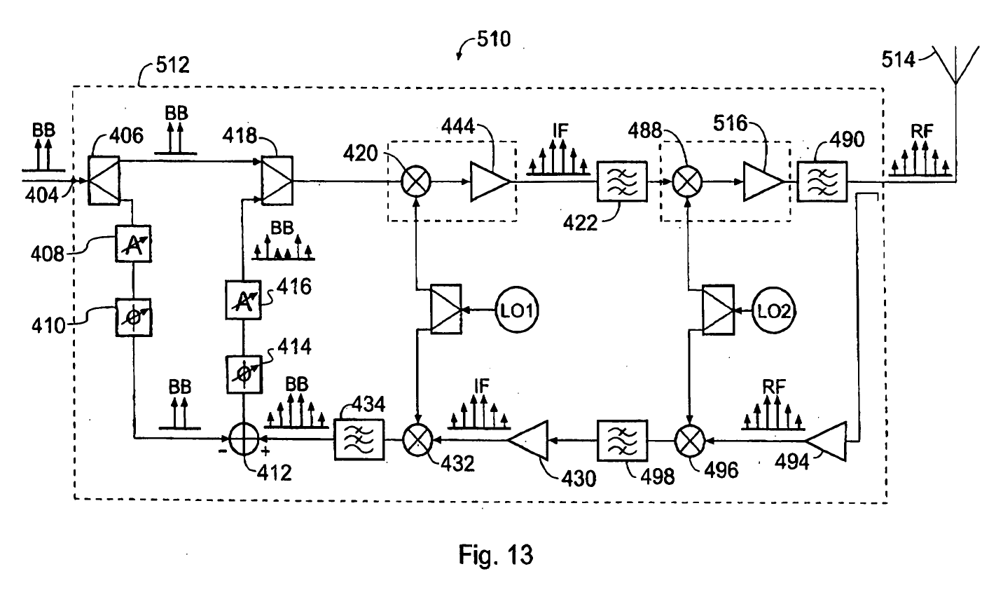

FIG. 13 is a block diagram, showing a radio transmitter architecture in accordance with the invention.

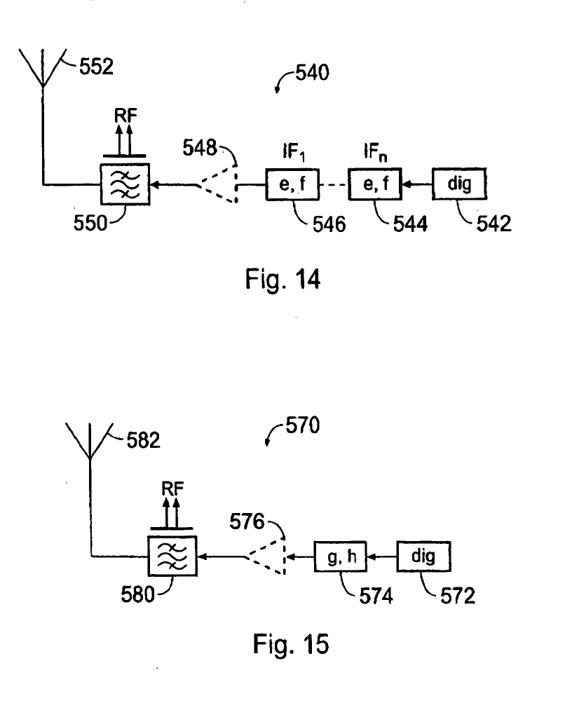

FIG. 14 is a schematic diagram, showing the general form of further radio transmitter architectures in accordance with the invention.

FIG. 15 is a schematic diagram, showing the general form of further radio transmitter architectures in accordance with the invention.

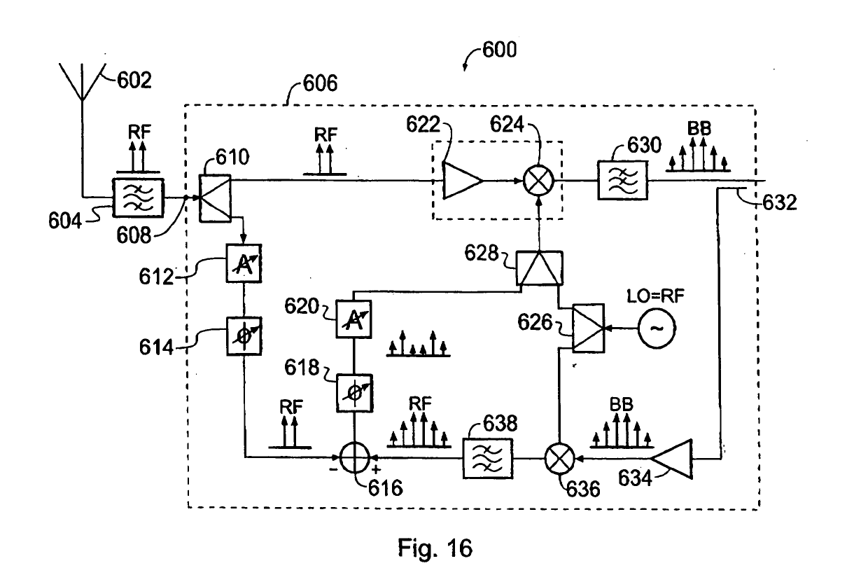

FIG. 16 is a block diagram, showing a radio receiver architecture in accordance with the invention.

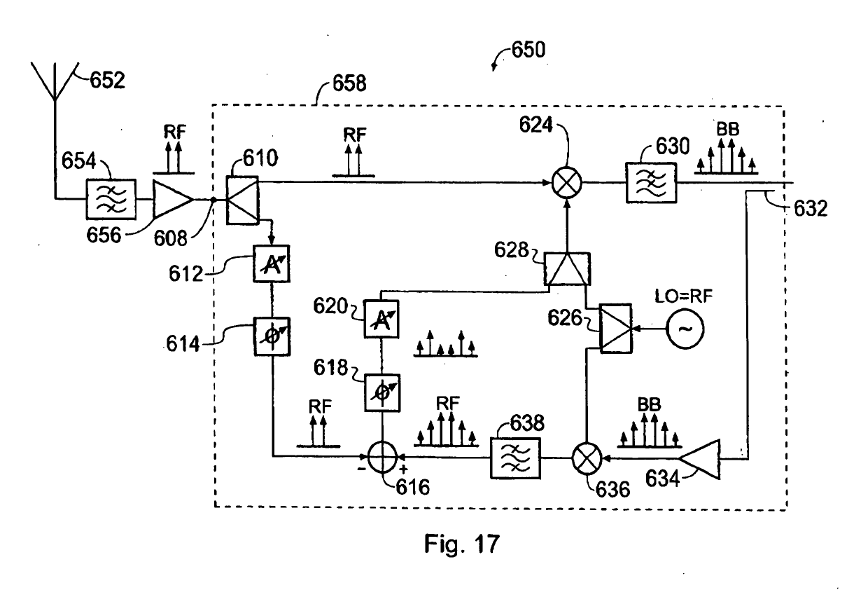

FIG. 17 is a block diagram, showing a radio receiver architecture in accordance with the invention.

### DETAILED DESCRIPTION OF PREFERRED EMBODIMENTS

FIG. 1 is a schematic diagram, showing the general form of mixer circuitry in accordance with the invention. As will be readily appreciated, such mixer circuitry is of particular applicability in radio transceiver circuits, in which a received radio frequency signal is downconverted to a lower frequency, or in which a baseband signal is upconverted to a higher frequency for radio frequency transmission.

Thus, FIG. 1 shows a circuit 10 having an input 12, at which it receives an input signal 14 at a first frequency F1. The first frequency F1 can for example be a radio frequency, if the circuit 10 forms part of a receiver front end; or it can be at baseband if the circuit 10 forms part of a transmitter; or it can be at an intermediate frequency, if the circuit 10 receives its input from another mixer circuit.

The input 12 is connected to a sampling point 16, at which a sample 18 of the input signal is taken. The sample 18 is supplied to an adder 20, in which it is subtracted from a comparison signal 22 (or, equivalently, added to the comparison signal 180° out of phase), with the correct amplitude. The result of the subtraction is to cancel the fundamental signals, to form an error signal 24, which is combined with the input signal 14 at point 26.

The combined input signal 14 and error signal 24 are supplied to one input of a first mixer 28, which receives its second input from a local oscillator at a local oscillator frequency F3. The resulting output signal 30 is then at an output frequency F2.

As is well known, the first mixer causes a frequency translation, such that, after selection of the desired component by means of suitable filtering, the output frequency F2 can be given either by:

F2=F1−F3, or

F2=F1+F3.

A sample of the output signal at the output frequency F2 is taken at a sampling point 32, and the resultant sample 34 is supplied to one input of a second mixer 36, which receives its second input from the local oscillator at the local oscillator frequency F3. The sample 34, at the output frequency F2, is then frequency retranslated to form the comparison signal 22 at the first frequency F1.

Frequency translation of the input signal in the first mixer 28 can result in distortion, for example as a result of intermodulation and/or harmonic distortion.

By cancelling the fundamental signals in the adder 20, and forming an error signal 24 which includes only the distortion components, this error signal can then be combined with the input signal 14 to predistort the mixer, and thereby produce the required linearised RF output signal 30.

FIG. 2 is a block schematic diagram of a radio receiver architecture in accordance with an aspect of the present invention.

Thus, FIG. 2 shows a receiver circuit 100, having an antenna 102, and a bandpass filter 104, which selects the wanted signals, without necessarily being able to achieve perfect cancellation of unwanted signals in adjacent bands and channels. The filtered signal is passed to a mixer 106, which is of the general form illustrated in FIG. 1.

That is, the input RF signal is applied to an input 108.

The input 108 is connected to a sampler 110, which takes a sample of the input signal. The sampled input signal is applied to an adjustable gain control block 112, an adjustable phase control block 114, and an amplifier 116, and then supplied to an adder 118, in which it is subtracted from a comparison signal (or, equivalently, added to the comparison signal 180° out of phase), with the correct amplitude and phase.

The result of the subtraction is to cancel the fundamental signals, to form a signal, which is also applied to an adjustable phase control block 120 and an adjustable gain control block 122, to form an error signal, which is combined in a combiner 124 with the input signal.

FIG. 2 also shows a switch 126, which can be opened or closed. When the switch is closed, the error signal is applied to the combiner 124, and the mixer output is linearised. When the switch is not closed, the loop remains open, and the mixer output is not linearized. The switch 126 is generally closed and, indeed, in other illustrated embodiments of the invention, the switch is not shown.

The input signal, predistorted by the addition of the error signal, is applied to an amplifier 126, and then to one input of a first mixer 128.

The amplifier 126 is operating in its linear region, but, since the error signal is fed back around the amplifier 126, the circuit can compensate to some extent for any nonlinearity introduced by the amplifier 126.

The first mixer 128 receives its second input from a local oscillator at a local oscillator frequency. The resulting output signal is then at an output intermediate frequency IF, having been frequency translated by the local oscillator frequency.

It will also be appreciated that, by suitable choice of the local oscillator frequency, the signals can be downconverted to baseband.

A sample of the output signal at the intermediate frequency IF is taken in a sampler 130, and the resultant sample is filtered in a low-pass filter 132. Depending on the architecture, and the frequency values concerned, the low-pass filter may be replaced by a bandpass filter. FIG. 2 also shows in dashed lines an alternative position 134 for the low-pass filter. The filtered sample is passed to an amplifier 136, and then supplied to one input of a second mixer 138, which receives its second input from the local oscillator at the local oscillator frequency.

The sample of the output signal is thus frequency retranslated, and is then filtered in a bandpass filter 140 to form the comparison signal, at the input radio frequency, which is supplied to the second input of the adder 118.

FIG. 3 shows an alternative form of radio receiver architecture in accordance with the present invention. The architecture of FIG. 3 is generally similar to that of FIG. 2. Therefore, components of the circuits which perform the same functions will be indicated by the same reference numerals, and will not be described further.

Thus, FIG. 3 shows a receiver circuit 150, having an antenna 102, and a bandpass filter 154, which selects the wanted signals, without necessarily being able to achieve perfect cancellation of unwanted signals in adjacent bands and channels. The filtered signal is passed to an amplifier 156, which is assumed to be linear. In this case, the amplifier 156 is outside the linearisation loop, and so it cannot compensate for any distortion introduced by the amplifier.

The amplified signal is passed to a mixer 158, which again is of the general form illustrated in FIG. 1.

In this case, the input signal is supplied to a splitter 160. Thus, the signal in the main path, and the sample which is used to form the error signal, are of the same magnitude. There is then no further amplification in the main signal path, and the amplifier 116, which acts on the sampled input in the FIG. 2 embodiment, can be omitted.

In FIG. 3, the low-pass filter 134 is shown in the output signal path, while noting the alternative position 132 for the filter.

Again, it will also be appreciated that, by suitable choice of the local oscillator frequency, the signals can be downconverted to baseband.

FIG. 4 is a block schematic diagram of another radio receiver architecture in accordance with the present invention.

Again, the architecture of FIG. 4 is generally similar to that of FIGS. 2 and 3. Therefore, components of the circuits which perform the same functions will be indicated by the same reference numerals, and will not be described further.

Thus, FIG. 4 shows a receiver circuit 180, having an antenna 182, and a bandpass filter 184, which selects the wanted signals, without necessarily being able to achieve perfect cancellation of unwanted signals in adjacent bands and channels. The filtered signal is passed to an amplifier 186, which is assumed to be linear. In this case, the predistortion signal is not fed back around the amplifier 186, and so it cannot compensate for any distortion introduced by the amplifier.

The amplified signal is passed to a mixer 188, which again is of the general form illustrated in FIG. 1.

However, the intermediate frequency output is supplied to digital circuitry 190, as will be described in more detail below.

Thus, the input RF signal is applied to an input 108 of the mixer 188.

The input 108 is connected to a splitter 160, which takes a sample of the input signal. The sampled input signal is applied to an adjustable gain control block 112, an adjustable phase control block 114, and then supplied to an adder 118, in which it is subtracted from a comparison signal (or, equivalently, added to the comparison signal 180° out of phase), with the correct amplitude. The result of the subtraction is to cancel the fundamental signals, to form a signal, which is also applied to an adjustable phase control block 120 and an adjustable gain control block 122, to form an error signal, which is combined in a combiner 124 with the input signal.

The input signal, predistorted by the addition of the error signal, is applied to one input of a first mixer 128.

The first mixer 128 receives its second input from a local oscillator at a local oscillator frequency. The resulting output signal is then filtered in a low pass filter 134, to form an output signal at an output intermediate frequency IF.

This output signal is then supplied to the digital circuitry 190, and in particular to an analog-digital converter 192. The resulting digitised signal is supplied to a digital signal processor 194, where it can be handled further, as required by the functionality of the receiver circuit. Amongst other things, a sample of the signal can be taken, and fed back through a digital-analog converter 196 to the mixer 188.

The sample is passed to an amplifier 136, and then supplied to one input of a second mixer 138, which receives its second input from the local oscillator at the local oscillator frequency.

The sample of the output signal is thus frequency retranslated, and is then filtered in a bandpass filter 140 to form the comparison signal, at the input radio frequency, which is supplied to the second input of the adder 118.

Therefore, by bringing the analog-digital conversion stage within the feedback loop, this allows the circuit to compensate for any distortion introduced thereby.

As is well known, a conventional superheterodyne receiver includes two or more mixer stages. In accordance with aspects of the invention, receiver circuits can compensate for any distortion which arises in any of these mixer stages.

FIG. 5 is a block schematic diagram of another radio receiver architecture in accordance with the present invention, in which two mixer stages are shown.

Again, the architecture of FIG. 5 is based around a mixer architecture which is generally similar to that of FIGS. 2 and 3. Therefore, components of the circuits which perform the same functions will be indicated by the same reference numerals, and will not be described further.

Thus, FIG. 5 shows a receiver circuit 210, having an antenna 212, and a bandpass filter 214, which selects the wanted signals, without necessarily being able to achieve perfect cancellation of unwanted signals in adjacent bands and channels. The filtered signal is passed to an amplifier 216, which is assumed to be linear.

The amplified signal is passed to a two-stage mixer 218, which includes the elements of the generalised form of mixer illustrated in FIG. 1.

Thus, the input RF signal is applied to an input 108 of the mixer 218.

The input 108 is connected to a splitter 160, which takes a sample of the input signal. The sampled input signal is applied to an adjustable gain control block 112, an adjustable phase control block 114, and then supplied to an adder 118, in which it is subtracted from a comparison signal (or, equivalently, added to the comparison signal 180° out of phase), with the correct amplitude. The result of the subtraction is to cancel the fundamental signals, to form a signal, which is also applied to an adjustable phase control block 120 and an adjustable gain control block 122, to form an error signal, which is combined in a combiner 124 with the input signal.

The input signal, predistorted by the addition of the error signal, is applied to one input of a first mixer 128.

The first mixer 128 receives its second input from a local oscillator at a first local oscillator frequency LO1. The resulting output signal is then at an output intermediate frequency IF, having been frequency translated by the local oscillator frequency.

The output signal at the intermediate frequency TF is filtered in a bandpass filter 220, and is then applied to an amplifier 222, and then to one input of a second mixer 224.

The amplifier 222 is operating in its linear region, but, since the error signal is fed back around the amplifier 222, the circuit can compensate to some extent for any nonlinearity introduced by the amplifier 222.

The second mixer 224 receives its second input from a local oscillator at a second local oscillator frequency LO2. The resulting signal is filtered in a low-pass filter 226 to form an output signal at baseband (BB), having been frequency translated by the second local oscillator frequency LO2.

A sample of the output signal at baseband is taken in a sampler 228, and the resultant sample is passed to an amplifier 230, and then supplied to one input of a third mixer 232, which receives its second input from the local oscillator at the second local oscillator frequency LO2.

The output from the third mixer 232, frequency retranslated to the intermediate frequency IF, is passed through a bandpass filter 234, and the filtered signal is passed to an amplifier 236, and then supplied to one input of a fourth mixer 238, which receives its second input from the local oscillator at the first local oscillator frequency LO1.

The signal is thus frequency retranslated to the input radio frequency, and is then filtered in a bandpass filter 140 to form the comparison signal, at the input radio frequency, which is supplied to the second input of the adder 118.

The mixer circuit 218 therefore downconverts the received radio frequency signal to baseband in two mixer stages, while compensating for any distortion introduced in either of those stages.

As discussed above with reference to FIG. 2, the front end amplifier can be included in the predistortion loop, allowing at least partial compensation for any nonlinearity of the amplifier. Thus, FIG. 6 shows a further radio receiver architecture 250 in accordance with the invention, having an antenna 252 and a bandpass filter 254 for received signals. The filtered received signals are passed to a two-stage mixer 256 which is generally similar to the mixer 218 shown in FIG. 5. Therefore, components of the circuits which perform the same functions will be indicated by the same reference numerals and will not be described further.

In the mixer 256, a sample of the input signal is taken in a coupler 260. The main signal path includes an amplifier 262 connected to the output of the combiner 124. Similarly, the sampled input signal, after amplitude and phase adjustment, is passed to the mixer 118 through an amplifier 264.

As previously discussed, the presence of the amplifier 262 within the loop means that any distortion introduced by the amplifier can be at least partially compensated.

Also, FIG. 6 shows the sample of the baseband output signal being filtered in a low-pass filter 266.

FIGS. 5 and 6 thus show architectures which allow for compensation for any distortion which arises in either of the two mixer stages of a superheterodyne receiver. Such compensation can also be achieved by cascading the single-stage mixer architectures described previously.

Thus, FIG. 7 is a block schematic diagram of a radio receiver architecture 280, having an antenna 282 and a bandpass filter 284. The received signals are passed through two mixer stages 286, 288, which respectively downconvert the received radio frequency signals to intermediate frequencies IF₁ and IFₙ. Although two such mixer stages are shown, the downconversion can take place in any convenient number of stages. Also, the final downconversion can be to baseband.

The mixer stages 286, 288 can each be the same as the mixer stage 106 shown in FIG. 2, or the mixer stage 158 shown in FIG. 3. If the first mixer stage 286 is as shown in FIG. 3, an amplifier 290 can be provided at the input.

Further, the output from the final mixer stage 288 can optionally be supplied to digital circuitry 292, corresponding to the digital circuitry 190 of FIG. 4, rather than being sampled in the analog domain.

FIGS. 5 and 6 also show architectures in which the output signal is sampled in the analog domain. However, as discussed above with reference to FIG. 4, the sampling can take place in the digital domain.

Thus, FIG. 8 is a block schematic diagram of a radio receiver architecture 300, having an antenna 302 and a bandpass filter 304. The received signals are passed through a two-stage mixer device 306, which downconverts the received radio frequency signal through an intermediate frequency to baseband.

The output from the mixer device 306 is supplied to digital circuitry 308, corresponding to the digital circuitry 190 of FIG. 4, rather than being sampled in the analog domain.

The mixer device 306 can be the same as the mixer stage 218 shown in FIG. 5, or the mixer stage 256 shown in FIG. 6. If the mixer stage 306 is as shown in FIG. 5, an amplifier 310 can be provided at the input.

As discussed above with reference to FIG. 1, the mixer architecture of the present invention is equally applicable to transmitter circuits, as it is to receiver circuits.

Thus, FIG. 9 is a block schematic diagram of a radio transmitter architecture in accordance with an aspect of the present invention.

FIG. 9 shows a transmitter circuit 400, having a mixer 402, which is of the general form illustrated in FIG. 1. The mixer 402 receives an input intermediate frequency signal at an input 404.

The input 404 is connected to a splitter 406, which takes a sample of the input signal. The sampled input signal is applied to an adjustable gain control block 408, an adjustable phase control block 410, and then supplied to an adder 412, in which it is subtracted from a comparison signal (or, equivalently, added to the comparison signal 180° out of phase), with the correct amplitude and phase. The result of the subtraction is to cancel the fundamental signals, to form a signal, which is also applied to an adjustable phase control block 414 and an adjustable gain control block 416, to form an error signal, which is combined in a combiner 418 with the input signal.

The input signal, predistorted by the addition of the error signal, is applied to one input of a first mixer 420.

The first mixer 420 receives its second input from a local oscillator at a local oscillator frequency. The resulting output signal is filtered in a bandpass filter 422, to produce an output signal at a desired transmit radio frequency, having been frequency translated by the local oscillator frequency.

The input signal is shown as being at an intermediate frequency, but it will also be appreciated that the transmitter can be a direct conversion transmitter, receiving signals at baseband, with suitable choice of the local oscillator frequency.

The output signal is then supplied through an amplifier 424 to a transmit antenna 426.

A sample of the output signal at the transmit frequency is taken in a sampler 428, and the resultant sample is passed to an amplifier 430, and then supplied to one input of a second mixer 432, which receives its second input from the local oscillator at the local oscillator frequency.

The sample of the output signal is thus frequency retranslated, and is then filtered in a low-pass filter 434 to form the comparison signal, at the input intermediate frequency, which is supplied to the second input of the adder 412.

The predistortion can thus compensate for any distortion introduced in the mixer 420.

FIG. 10 shows an alternative form of radio transmitter architecture in accordance with the present invention. The architecture of FIG. 10 is generally similar to that of FIG. 9. Therefore, components of the circuits which perform the same functions will be indicated by the same reference numerals, and will not be described further.

FIG. 10 shows a radio transmitter 440, including a mixer 442, which is in accordance with FIG. 1.

In the circuit of FIG. 10, the output from the first mixer 420 is applied to an amplifier 444. The amplifier 444 is operating in its linear region, but, since the error signal is fed back around the amplifier 444, the circuit can compensate to some extent for any nonlinearity introduced by the amplifier 444.

Again, the input signal is shown as being at an intermediate frequency, but it will also be appreciated that the transmitter can be a direct conversion transmitter, receiving signals at baseband, with suitable choice of the local oscillator frequency.

The transmitter architectures shown herein are also suitable for use when the received signals are digital.

FIG. 11 is a block diagram showing a radio transmitter architecture in accordance with the present invention, in which digital input signals are received, at baseband or at an intermediate frequency. The transmitter 460 includes a mixer circuit 462 for upconverting the received signals, a power amplifier 463, and a transmit antenna 464.

The received digital signals are supplied to a digital signal processor (DSP) 466, which carries out the same signal cancellation, and amplitude and phase adjustment steps, which are carried out in the transmitter circuit of FIG. 9. The output signal from the DSP 466 is supplied to a digital-analog converter 467, and then to the first input of a first mixer 468. The second input of the mixer 468 comes from a local oscillator at a local oscillator frequency LO. The resulting upconverted signal is passed through a bandpass filter 469, and then to the mixer output.

The mixer output signal is sampled, and the resulting sample is passed to an amplifier 470, and then to the first input of a second mixer 472. The second input of the mixer 472 also comes from the local oscillator at the local oscillator frequency.

The sample, which has been frequency retranslated in the mixer 472, is then filtered in a low-pass filter 473, and supplied to an analog-digital converter 474, and then to the DSP 466.

The DSP 466 predistorts the received input signals, by an error signal, the error signal being formed as described previously, by taking a sample of the input signal, and then, with appropriate gain and phase adjustment, subtracting this from the frequency retranslated sample of the output to cancel the fundamental component thereof, with subsequent gain and phase adjustment, as required.

In the situation where the transmit signals are generated in digital form, this architecture allows at least partial compensation of any distortion which is introduced by the digital-analog and analog-digital conversions. This architecture also has the advantage that the amplitude and phase optimization, and the signal cancellation, can be carried out in the digital domain, allowing improved accuracy to be achieved.

It will be appreciated that, in the transmitter circuit of FIG. 11, the amplifier could be brought within the loop, as in the transmitter of FIG. 10.

FIG. 12 is a block schematic diagram of another radio transmitter architecture in accordance with the present invention, in which two mixer stages are shown.

Again, the architecture of FIG. 12 is based around a mixer architecture which is generally similar to that of FIGS. 9 and 10. Therefore, components of the circuits which perform the same functions will be indicated by the same reference numerals, and will not be described further.

FIG. 12 shows a transmitter circuit 480, having a two-stage mixer 482, which includes the elements of the generalised form of mixer illustrated in FIG. 1. The mixer output signals are supplied to a power amplifier 484 and a transmit antenna 486

The input baseband signal is applied to an input 404 of the mixer 482.

The input 404 is connected to a splitter 406, which takes a sample of the input signal. The sampled input signal is applied to an adjustable gain control block 408, an adjustable phase control block 410, and then supplied to an adder 412, in which it is subtracted from a comparison signal (or, equivalently, added to the comparison signal 180° out of phase), with the correct amplitude. The result of the subtraction is to cancel the fundamental signals, to form a signal, which is also applied to an adjustable phase control block 414 and an adjustable gain control block 416, to form an error signal, which is combined in a combiner 418 with the input signal.

The input signal, predistorted by the addition of the error signal, is applied to one input of a first mixer 420.

The first mixer 420 receives its second input from a local oscillator at a first local oscillator frequency LO1. The resulting output signal is then at an output intermediate frequency IF, having been frequency translated by the local oscillator frequency.

The output signal at the intermediate frequency IF is passed to an amplifier 444, and is then filtered in a bandpass filter 422. The filtered signal is then applied to one input of a second mixer 488.

The amplifier 444 is operating in its linear region, but, since the error signal is fed back around the amplifier 444, the circuit can compensate to some extent for any nonlinearity introduced by the amplifier 444.

The second mixer 488 receives its second input from a local oscillator at a second local oscillator frequency LO2. The resulting signal is filtered in a bandpass filter 490 to form an output signal at a transmit frequency RF, having been frequency translated by the second local oscillator frequency LO2.

A sample of the radio frequency output signal is taken in a sampler 492, and the resultant sample is passed to an amplifier 494, and then supplied to one input of a third mixer 496, which receives its second input from the local oscillator at the second local oscillator frequency LO2.

The output from the third mixer 496, frequency retranslated to the intermediate frequency IF, is passed through a bandpass filter 498, and the filtered signal is passed to an amplifier 430, and then supplied to one input of a fourth mixer 432, which receives its second input from the local oscillator at the first local oscillator frequency LO1.

The signal is thus frequency retranslated to baseband frequency, and is then filtered in a low-pass filter 434 to form the comparison signal, at baseband, which is supplied to the second input of the adder 412.

The mixer circuit 480 therefore upconverts the received radio frequency signal from baseband to the desired output radio frequency in two mixer stages, while compensating for any distortion introduced in either of those stages.

As discussed above with reference to FIG. 10, the final power amplifier can be included in the predistortion loop, allowing at least partial compensation for any nonlinearity of the amplifier. Thus, FIG. 13 shows a further radio receiver architecture 510 in accordance with the invention, having a mixer 512 and a transmit antenna 514. The architecture of FIG. 13 is generally similar to that of FIG. 12. Therefore, components of the circuits which perform the same functions will be indicated by the same reference numerals, and will not be described further.

In the mixer 512 of FIG. 13, the main signal path includes an amplifier 516 connected to the output of the second mixer 488. As in other previously discussed embodiments, the presence of the amplifier 516 within the loop means that any distortion introduced by the amplifier can be at least partially compensated.

It will be appreciated that radio transmitter architectures similar to those of FIGS. 12 and 13 are possible, in which the baseband input signals are received in digital form. In that case, the baseband processing can be carried out in the digital domain, as described in detail with reference to FIG. 11.

FIGS. 12 and 13 show architectures which allow for compensation for any distortion which arises in either of the two mixer stages of a transmitter. Such compensation can also be achieved by cascading the single-stage mixer architectures described previously.

Thus, FIG. 14 is a block schematic diagram of a radio transmitter architecture 540, receiving input signals at baseband or a low intermediate frequency, which may optionally come from digital circuitry 542. The received signals are passed through two mixer stages 544, 546, which respectively upconvert the received signals to intermediate frequencies IFₙ and IF₁. Although two such mixer stages are shown, the upconversion can take place in any convenient number of stages.

The mixer stages 544, 546 can each be the same as the mixer stage 402 shown in FIG. 9, or the mixer stage 442 shown in FIG. 10. If the final mixer stage 546 is as shown in FIG. 9, an amplifier 548 can be provided at the output. The output signals are then supplied to a bandpass filter 550 and an antenna 552.

FIGS. 11 and 12 also show architectures in which the input signal is received in the analog domain. However, as mentioned above, the signal can be received in the digital domain.

Thus, FIG. 15 is a block schematic diagram of a radio transmitter architecture 570, including digital circuitry 572, which provides analog signals at baseband or a low intermediate frequency. These signals are passed through a mixer circuit 574, which upconverts the received signals in two mixer stages to radio frequency.

The mixer circuit 574 can be the same as the mixer circuit 482 shown in FIG. 12 or the mixer stage 512 shown in FIG. 13. If the mixer circuit 574 is as shown in FIG. 12, an amplifier 576 can be provided at the output. The output signals are then supplied to a bandpass filter 580 and an antenna 582.

In the embodiments of the invention described above, an error signal is formed after frequency retranslation of the output signal, and the error signal is combined with the input signal to predistort the mixer in the main signal path.

However, in the case of a direct conversion receiver, where a received signal is downconverted to baseband in a single mixer stage, the local oscillator is at the same frequency as the input signal. As a result, it is possible to combine the error signal with the local oscillator signal supplied to the mixer, instead of with the input signal, and to achieve the required compensation in that way. This may allow alleviation of any potential instability problems.

FIG. 16 is a block schematic diagram of a direct conversion radio receiver architecture in accordance with an aspect of the present invention.

Thus, FIG. 16 shows a receiver circuit 600, having an antenna 602, and a bandpass filter 604, which selects the wanted signals, without necessarily being able to achieve perfect cancellation of unwanted signals in adjacent bands and channels. The filtered signal is passed to a mixer 606.

The input RF signal is applied to an input 608, which is connected to a splitter 610, which forms a sample of the input signal. The sampled input signal is applied to an adjustable gain control block 612, and an adjustable phase control block 614, and then supplied to an adder 616, in which it is subtracted from a comparison signal (or, equivalently, added to the comparison signal 180° out of phase), with the correct amplitude and phase. The result of the subtraction is to cancel the fundamental signals, to form a signal, which is also applied to an adjustable phase control block 618 and an adjustable gain control block 620, to form an error signal.

The input signal is applied to an amplifier 622, and then to one input of a first mixer 624.

The amplifier 622 is operating in its linear region, but the circuit can compensate to some extent for any nonlinearity introduced by the amplifier 622.

In order to downconvert the received signals to baseband, the circuit includes a local oscillator LO at the receive radio frequency. The local oscillator signal is passed to a splitter 626. One part of the local oscillator is then passed to a combiner 628, where it is combined with the error signal mentioned above.

The output signal from the combiner 628 is then passed to the second input of the first mixer 624. Thus, the error signal can compensate for any distortion which would be created in the mixer 624.

The resulting output signal from the mixer 624 is then at baseband, having been frequency translated by the local oscillator frequency, and is filtered in a low-pass filter 630.

A sample of the output signal at baseband is taken in a sampler 632, and the resultant sample is passed to an amplifier 634, and then supplied to one input of a second mixer 636, which receives its second input at the local oscillator frequency from the splitter 626.

The sample of the output signal is thus frequency retranslated, and is then filtered in a bandpass filter 638 to form the comparison signal, at the input radio frequency, which is supplied to the second input of the adder 616.

FIG. 17 shows an alternative form of radio receiver architecture in accordance with the present invention. The architecture of FIG. 17 is generally similar to that of FIG. 16. Therefore, components of the circuits which perform the same functions will be indicated by the same reference numerals, and will not be described further.

Thus, FIG. 17 shows a receiver circuit 650, having an antenna 652, and a bandpass filter 654, which selects the wanted signals, without necessarily being able to achieve perfect cancellation of unwanted signals in adjacent bands and channels. The filtered signal is passed to an amplifier 656, which is assumed to be linear. In this case, the predistortion signal is not fed back around the amplifier 656, and so it cannot compensate for any distortion introduced by the amplifier.

The amplified signal is passed to a mixer 658. There is then no further amplification in the main signal path, and the amplifier 622 from the FIG. 16 embodiment is omitted.

FIGS. 16 and 17 therefore show mixers in which predistortion of the mixer in the main path is achieved by combining the error signal with the local oscillator signal, and applying the modified local oscillator signal to the mixer.

It will be appreciated that, in the architectures of FIGS. 16 and 17, the baseband signal processing can be carried out in the digital domain, as described in more detail above with reference to FIG. 4.

There are therefore described various radio transceivers, in which the distortion introduced by the mixer circuitry can be at least partially compensated.

1. A mixer architecture, comprising:
a first local oscillator, at a first local oscillator frequency;
a first mixer, in which an input signal is frequency translated by the first local oscillator frequency from first frequency to a second frequency to generate a mixer output signal;
a second mixer, in which a sample of the mixer output signal at the second frequency is retranslated by the first local oscillator frequency to the first frequency;
means for forming an error signal, by subtracting a sample of the input signal from the retranslated sample of the output signal, with gain and phase control; and
means for combining the error signal with the input signal when it is applied to the first mixer.

2. A mixer architecture as claimed in claim 1, comprising means for applying gain and phase adjustment to a signal obtained by subtracting a sample of the input signal from the sample of the retranslated output signal.

3. A mixer architecture as claimed in claim 1, comprising means for applying gain and phase adjustment to the sample of the input signal.

4. A mixer architecture as claimed in claim 1, comprising a filter, connected to filter the frequency retranslated sample of the output signal, before subtraction from the sample of the input signal.

5. A mixer architecture as claimed in claim 1, comprising a filter, connected to filter the mixer output signal, before forming the sample thereof.

6. A mixer architecture as claimed in claim 1, comprising a filter, connected to filter the sample of the mixer output signal, before frequency retranslation.

7. A receiver circuit, comprising a mixer architecture as claimed in claim 1, wherein the first local oscillator frequency is selected to downconvert the input signal from radio frequency to an intermediate frequency.

8. A receiver circuit, comprising a mixer architecture as claimed in claim 1, wherein the first local oscillator frequency is selected to downconvert the input signal from radio frequency to baseband.

9. A receiver circuit, comprising:
a first mixer architecture as claimed in claim 1, wherein the first local oscillator frequency of the first mixer architecture is selected to downconvert the respective input signal from radio frequency to an intermediate frequency; and
a second mixer architecture as claimed in claim 1, wherein the first local oscillator frequency of the second mixer architecture is selected to downconvert the respective input signal from the intermediate frequency to baseband.

10. A receiver circuit, comprising:
a first mixer architecture as claimed in claim 1, wherein the first local oscillator frequency of the first mixer architecture is selected to downconvert the respective input signal from radio frequency to an intermediate frequency;
a second local oscillator, at a second local oscillator frequency;
a third mixer; in which the output signal from the first mixer architecture is frequency translated by the second local oscillator frequency from the second frequency to a third frequency to generate an output signal and
a fourth mixer, in which the output signal from the third mixer is retranslated by the second local oscillator frequency to the second frequency, to form the sample of the output signal of the first mixer architecture.

11. A receiver circuit, comprising a mixer architecture as claimed in claim 1, further comprising an amplifier, connected to amplify received input signals before the first mixer.

12. A receiver circuit, comprising a mixer architecture as claimed in claim 1, further comprising a digital signal processor, connected to receive the output signal from the mixer architecture, and to form the sample of the output sample in the digital domain.

13. A receiver circuit, comprising a mixer architecture as claimed in claim 1,
wherein the error signal is combined with the input signal, and the resulting combined signal is applied to a first input of the first mixer, and
wherein the first local oscillator signal is applied to a second input of the first mixer.

14. A receiver circuit, comprising a mixer architecture as claimed in claim 1,
wherein the first local oscillator frequency is selected to downconvert the input signal from radio frequency to baseband,
wherein the input signal is applied to a first input of the first mixer, and
wherein the error signal is combined with the first local oscillator signal and the resulting combined signal is applied to a second input of the first mixer.

15. A transmitter circuit, comprising a mixer architecture as claimed in claim 1, wherein the first local oscillator frequency is selected to upconvert the input signal to radio frequency from an intermediate frequency.

16. A transmitter circuit, comprising a mixer architecture as claimed in claim 1, wherein the first local oscillator frequency is selected to upconvert the input signal to radio frequency from baseband.

17. A transmitter circuit, comprising:
a first mixer architecture as claimed in claim 1, wherein the first local oscillator frequency of the first mixer architecture is selected to upconvert the respective input signal to an intermediate frequency from baseband; and
a second mixer architecture as claimed in any one of claims 1-6, wherein the first local oscillator frequency of the second mixer architecture is selected to upconvert the respective input signal to radio frequency from the intermediate frequency.

18. A transmitter circuit, comprising:
a first mixer architecture as claimed in any one of claims 1-6 claim 1, wherein the first local oscillator frequency of the first mixer architecture is selected to upconvert the respective input signal from baseband to an intermediate frequency;
a second local oscillator, at a second local oscillator frequency;
a third mixer, in which the output signal from the first mixer architecture is frequency translated by the second local oscillator frequency from the second frequency to a third frequency to generate an output signal; and
a fourth mixer, in which a sample of the output signal from the third mixer is retranslated by the second local oscillator frequency to the second frequency, to form the sample of the output signal of the first mixer architecture.

19. A transmitter circuit, comprising a mixer architecture as claimed in claim 1, further comprising an amplifier, connected to amplify the mixer output signals.

20. A transmitter circuit, comprising a mixer architecture as claimed in claim 1, further comprising a digital signal processor,
wherein the digital signal processor is connected to receive the input signal in digital form, and to form the error signal and combine the error signal with the input signal in the digital domain.
